(19) United States
(12) Patent Application Publication
(10) Pub. No.: US 2009/0061213 A1
(43) Pub. Date: Mar. 5, 2009

(54) METHOD FOR FABRICATING MINUTE CONDUCTIVE STRUCTURES ON SURFACES

(75) Inventors: Stefan Bahnmuller, Koln (DE); Stefanie Eiden, Leverkusen (DE); Stephan Michael Meier, Grevenbroich (DE); Christian Etienne Hendriks, Eindhoven (NL); Ulrich Schubert, Ismaning (DE)

Correspondence Address: NORRIS, MCLAUGHLIN & MARCUS, P.A., 875 THIRD AVE, 18TH FLOOR, NEW YORK, NY, 10022, US

(73) Assignee: Bayer MaterialScience AG, Leverkusen (DE)

(21) Appl. No.: 12/171,513

(22) Filed: Jul. 11, 2008

(30) Foreign Application Priority Data
Jul. 19, 2007 (DE) 10 2007 033 523.9
Sep. 12, 2007 (DE) 10 2007 043 396.6

(51) Int. Cl. B32B 5/00; B05D 5/12

(52) U.S. Cl. 428/332; 427/58

(57) ABSTRACT

Method for producing small and micro conductive structures on surfaces by (hot) stamping and/or nanoscale imprinting microstructures on the surfaces, targeting conductive material into the channels thus created with the aid of capillary action, and appropriately after-treating the conductive material.

The present invention pertains to a method that enables small and micro conductive structures to be fabricated on surfaces. In this context, small and micro structures are structures that generally can only be seen by the naked eye with the help of optical aids. This is achieved by fabricating micro-channels by (hot) stamping and/or imprinting nanoscale depressions, subsequent targeted introduction of conductive material into the depressions thus created, assisted by the physical effect of capillary action, and finally suitable after-treatment of the conductive material.

### BACKGROUND OF THE INVENTION

There is a need to equip the surfaces particularly of electrically non-conductive or poorly conductive transparent objects with electrically conductive structures, without thereby affecting their optical or mechanical and physical properties. Furthermore, there is a need to equip the surfaces with such structures that cannot be seen by the naked eye, if possible, without the surface's transparency, translucence and lustre, for example, being negatively influenced. It is generally recognised that such a structure must have a characteristic measurement below 25 μm. For example, a line of any length but with a maximum width and depth of 25 μm.

There are various printing techniques that can apply small structures to substrates. One of these printing techniques is the so-called inkjet technique, which is available in various embodiments. A positionable jet is used to apply droplets or liquid jets on a substrate. The diameter of the jet used here is the main influencing factor on the width of a line created by inkjet. Furthermore, according to a rule which has yet to be disputed, the line width is at least as wide or mainly wider than the diameter of the jet used. As a result, for example, when using a jet with an outlet opening of 60 μm, a line width of ≧60 μm is produced [J. Mater. Sci. 2006, 41, 4153; Adv. Mater. 2006, 18, 2101]. An example of an ink based on carbon nanotubes as conductive carrier material for printing conductive lines is published in US 2006/124028 A1.

It is therefore suggested that this opening be simply reduced in size to approximately 15-20 μm to obtain the desired line width of ≦25 μm. This solution cannot be put into practice, as reducing the diameter means the rheological limits of the printing substances used (varnishes, inks, conductor pastes, etc.) start to dominate. This often makes the printing substances unusable for the application. Particular complications possible here are due to the jet blocking, as the printing substance contains dispersed particles. Furthermore, the rheological requirements (determined viscosity and surface tension, as well as contact angle and wetting of the substrate) cannot be adjusted independently of each other, so that an ink, which is still printable with such a jet, does not display the desired properties in the printed image on the substrate.

Alternative, commercial printing technologies, such as offset or screen printing, are generally not able to apply such minute structures onto a surface.

A further approach to creating small and micro structures is to use suitable methods (e.g. plasma method) to treat the substrate in such a way that areas of differing wettability are formed, for example by using masks that contain a negative of the structure to be created. This results, for example, in line widths of 5 μm using aqueous polymers [Science 2000, 290, 2123]. Using a similar approach, it was possible to create structures with widths less than 5 μm. These methods, however, do require labour-intensive lithographic stages. [Nature Mater. 2004, 3, 171].

US 2006/188823 A1 publishes a process in which an additional, photo-active coating is applied to the substrate. A structure is then physically imprinted on it. The resulting structure is then cured using UV light. Furthermore, subsequent etching and curing stages are provided. The exact nature of the conductive materials used to fill the structures formed is, however, not published. This process is relatively difficult and labour-intensive due to the many treatment stages.

A simple method, using only mechanical means, to create small structures without creating a conductive structure, particularly on polymers, uses (hot) stamping or nanoscale imprinting. Essentially, this involves using pressure to press dies onto the substrate and thus achieve a cast of the negative of the structure of the die on the surface. In particular, the hot stamping of polymer substrates with dies above the glass transition temperature of the polymer has already been used here to create structures with a diameter of 25 nm. In contrast to the aforementioned lithographic method, the stencil used (also called master) in the stamping method can always be re-used intact. [Appl. Phys. Lett. 1995, 67, 3114; Adv. Mater. 2000, 12, 189; Appl. Phys. Lett. 2002, 81, 1955].

In order to obtain only conductive structures from the structures obtained, these must be filled with suitable material. For this approach, blade and wiping methods are mainly suitable. Such a method is known, for example, from WO 1999 45375 A1. In this arrangement, an excess of the material, with which the structures are to be filled, is applied to the substrate and distributed into the structures, in which the material should remain, while the remaining substrate is extensively cleaned of the material using the wiping technology. The disadvantage of this method is that, besides the potential high losses of filling material, it is very difficult to ensure that the substrate is completely free of residues of the filling material in places not to be filled. A process is published in U.S. Pat. No. 6,911,385 B1, in which a continuous and discontinuous stamping method is used. In both cases, a conductive ink is applied onto a surface as a homogeneous film and material is subsequently removed by stamping from those places where the surface should not be conductive. An alternative process is published in which a conductive ink is applied through the apertures of a porous stamping pattern (die), which remains on the substrate. In the places where the die comes into direct contact with the substrate when the ink is applied, no ink is applied and the desired structure is thus attained.

Minute structures can be filled essentially by using capillary action, its sensible use, however, requiring that the filler material is applied in a targeted manner into the created structure to avoid material wastage. Small structures (or tubes, see J. Colloid Interface Sci. 1995, 172, 278) filled by capillary action has already been described, particularly with liquid pre-polymers (e.g. polymethyl acrylate; J. Phys. Chem. B 1997, 101, 855), or aqueous solutions of biomolecules such as DNA in microfluidics components (Chem Phys Chem 2003, 4, 1291). However, filling such structures with material, that is subsequently made conductive, has not yet been published.

Thus, it was the object of the present invention to create conductive structures on surfaces, said structures lying below the minimum perceptible difference of the human, naked eye (i.e. below 25 μm) and having no other influence on the properties of the component. Thus, the further disadvantages of known processes described above should be avoided.

### SUMMARY OF THE INVENTION

For this purpose, it was found that a combination of stamping a depression into the substrate surface and using ink formulations containing conductive nanoparticles with subsequent sintering of the nanoparticles to form continuous conducting paths can be used. FIG. 1 gives a short illustration of the procedure.

The invention relates to a method of fabricating electrically conductive structures that have a measurement in two dimensions not exceeding 25 μm, on a substrate with a mouldable surface, by which channels are created on the surface of the substrate by mechanical and optionally additional thermal effect, said channels preferably having a measurement in one dimension not exceeding 25 μm (for example having a width at the base of the channels of less than 25 μm), an ink, preferably a dispersion of conductive particles, is applied to the channels, with which said ink conductive structures can be created, the channels are filled with the ink using capillary action, and the ink is converted into conductive structures by introducing energy, particularly by heat treatment.

The invention also relates to the substrates obtained according to the aforementioned new method, which display structures that have a measurement in two dimensions not exceeding 25 μm.

### DETAILED DESCRIPTION

First, a press die or press roller, each provided with a raised microstructure (positive), is preferably pressed onto the substrate, which is preferably a polymer substrate, in order to stamp a negative of the microstructure of the die onto the surface of the substrate. If a polymer substrate is used, then the die or press roller is preferably heated to at least the temperature of glass transition point of the polymer substrate used here. It is particularly preferred that the die or press roller temperature lies at least 20° C. above the glass transition temperature. It is furthermore preferred that microstructure on the surface of the die or press roller have a measurement in one dimension of not more than 25 μm, preferably from 25 μm to 100 nm, particularly preferably from 10 μm to 100 nm, most particularly preferably from 1 μm to 100 nm. The duration of pressing the die into the substrate should be particularly 1 to 60 minutes, preferably 2 to 5 minutes, particularly preferably pressed for 3 to 4 minutes. The use of a press roller in contrast requires shorter pressing times, as greater pressure is then used. The creation of stamped structures is carried out continuously in this arrangement.

In this procedure, the relative speed of substrate to roller is 10 to 0.00001 m/s, preferably 1 to 0.0001 m/s, particularly preferably 0.1 to 0.0001 m/s.

However, the parameters of pressure, temperature and duration of pressing correlate such that, at higher temperature or greater pressure, the pressing time can be reduced. As a result, correspondingly shorter times and thus higher component throughput rates are conceivable with the method presented here. Furthermore, methods that show the desired result using high pressures and short duration even at correspondingly low temperature of dies or rollers are thus also conceivable.

It is therefore preferred that the roller is pressed onto the substrate, while the substrate is pulled under this roller and the roller thereby turns, or the roller is driven and thus pushes the substrate while stamping the channels into the substrate.

The channels thus produced are then filled with an ink, with which conductive structures can be created. In the most simple case, the ink consists of a solvent or suspension liquid and an electrically conductive material or a precursor compound for an electrically conductive material.

The ink can contain, for example, electrically conductive polymers, metals or metal oxides, carbon particles or semi-conductors. An ink is preferred that contains nanoparticles of a conductive material, particularly of carbon nanotubes and/or metal particles dispersed in a solvent, for example water, said nanoparticles leading to a continuously conductive structure by means of sintering. It is particularly preferred for the ink to contain nanoparticles of silver in water, which lead to a continuously conductive structure by means of sintering the silver particles. Suitable metal oxides which can be used include, but are not limited to, indium tin oxide, fluorine tin oxide, antimony tin oxide, zinc aluminium oxide. Semi-conductors which can be used comprise, for example, zinc selenite, zinc tellurite, zinc sulfide, cadmium selenite, cadmium tellurite, cadmium sulfide, lead selenite, lead sulfide, lead tellurite and indium arsenite. Furthermore, for improved exploitation of the capillary actions, the ink preferably used in the present method should wet the substrate optimally, i.e. form a contact angle as low as possible on the substrate not exceeding 60°, preferably not exceeding 30°, and surface tension as high as possible exceeding 20 N/m, preferably exceeding 40 N/m, particularly preferably exceeding 50 N/m. If the ink, as described above, contains nanoparticles, then these should be particularly smaller than 1 μm, preferably smaller than 100 nm in their greatest dimension. Particularly preferable are nanoparticles smaller than 80 nm, particularly smaller than 60 nm and displaying a bimodal particle size distribution.

This ink is then dosed into the channels created as described above. It is preferred that individual droplets are dosed into the channels. Particularly preferred for dosing is an ink printer with a pressure head, whose pressure jets are arranged precisely over the channels and jets individual droplets into the channels.

In order to fill the maximum length of channel on the substrate with the ink using the present method in a preferred variation, it may be necessary to dose several times in an individual channel. It is therefore preferable that the ink is dosed several times at regular intervals along the channels. Alternatively, the ink can be dosed continuously by the preferably used inkjet printer onto the substrate passing under the pressure head. This preferably occurs at suitable intervals, dependent on the type and shape of channels on the substrate. For example, a continuous ink stream can be applied with uninterrupted lines orientated along the flow-through direction of the substrate. In the case of interrupted lines, for example, the dosing would be stopped for the duration of the interruption. In this case, the term interrupted line can also be understood to be a line not running parallel to the flow-through direction of the substrate, for example, lines running at right angles to the flow-through direction. For this purpose, pressure jets can be provided at regular intervals adjacent to each other to fill the whole channel structure during a single passage.

In a preferred variation, movable pressure heads are provided, which follow the stamped channel structure during the relative movement of the substrate under them. For example, this is the case when curved, preferably corrugated channels have been stamped along the orientation of the substrate. When the pressure heads can move at right angles to the flow-through direction of the substrate, an oscillation in the pressure heads in a perpendicular direction to the substrate relative to the latter leads to a wave movement. Hence, a corrugated structure can be continuously filled with ink. Particularly with interrupted structures, this can be extended to assemblies, where the pressure heads follow the flow-through direction of the substrate for a short time. This means that a pressure head device is provided that permits movement in two dimensions.

The substrates that can be used in the method according to the invention are substrates with mouldable surfaces, e.g. glass, ceramics or polymers, particularly transparent polymers. These substrates are electrical insulators. It is however desirable to equip the components resulting from the substrate with conductive properties at least at certain locations.

Polymer materials frequently have special properties, that make them preferred materials in many fields of application. This comprises, for example, their comparatively high flexibility, the frequently lower density with identical or similar load carrying capacity in comparison to anorganic materials and the wide design freedom due to the easier mouldability of these materials. Some materials (e.g. polycarbonate, polypropylene, polymethyl methacrylate (PMMA) and some PVC types) simultaneously display additional special properties, such as, for example, optical transparency. Preferred polymers to be used in the present method are transparent and/or have a high glass transition temperature. Polymers with a high glass transition temperature refers to polymers with a glass transition temperature above 100° C. Particularly preferred polymers to be used in the present method are selected from the group consisting of polycarbonate, polyurethane, polystyrene, polymethyl(meth)acrylate and polyethylene terephthalate.

In accordance with the stages described above, an ink is formed in the created channels, from which said ink the structures with the desired conductivity are created by suitable after-treatment.

According to the invention, this after-treatment comprises the input of energy into the created channels filled with ink. In the case of the preferred use of inks with conductive polymers in solvent suspensions, the particles present in suspension in the solvent are fused together, for example, by heating the suspension on the substrate, while the solvent evaporates. The after-treatment stage is preferably carried out at the melting temperature of the conductive polymer, particularly preferably above its melting temperature. This results in continuous conductor paths.

In the case of the alternative, preferred use of inks containing carbon nanotubes, the solvent between the dispersed carbon particles present is evaporated by the thermal after-treatment of the substrate surface, in order to obtain continuous, percolating paths made of conductive carbon. The treatment stage is carried out in the evaporation temperature range for the solvent contained in the ink, preferably above the evaporation temperature of the solvent. When the percolation limit is reached, the conductor paths according to the invention are formed.

If the suspensions of metal nanoparticles in solvents as described above are used in another preferred variation of the method, then the after-treatment consists of heating the complete component or just the conductor paths to a temperature, at which the metal particles sinter together and the solvent at least partially evaporates. In this arrangement, metal particles with the smallest possible particle diameter are advantageous, as the sinter temperature is proportional to the particle size in nanoscale particles, so that the sinter temperature required for smaller particles is lower than for larger ones. In this arrangement, the boiling point of the solvent is as near as possible to the sintering temperature of the particles and is as low as possible, in order to protect the substrate from thermal effects. A preferred ink solvent to be used is one with a boiling temperature of <250° C., particularly preferred with a temperature <200° C., particularly with a temperature ≦100° C. All temperatures given here refer to boiling temperatures at a pressure of 1013 hPa. Particularly preferred solvents are n-alkanes with up to 12 carbon atoms, alcohols with up to four carbon atoms, such as for example, methanol, ethanol, propanol and butanol, ketones and aldehydes with up to five carbon atoms, such as for example acetone and propanal, water, as well as acetonitrile, dimethyl ether, dimethyl acetamide, dimethyl formamide, N-methyl-pyrrolidone (NMP), ethylene glycol and tetrahydrofuran. The sintering stage is carried out at the given temperature until a continuous conductor path is formed. A preferred duration for sintering is from one minute to 24 hours, particularly preferred from five minutes to 8 hours, particularly preferred from two to 8 hours.

The invention also relates to the use of an ink, with which conductive structures can be created, to fabricate substrates, which display conductive structures on their surface, that have a measurement in one dimension not exceeding 25 μm, preferably from 20 μm to 100 nm, particularly preferably from 10 μm to 100 nm, most particularly preferably from 1 μm to 100 nm, the ink preferably being a suspension of conductive particles, as described above, and the substrate preferably being transparent, for example glass, transparent ceramics or a transparent polymer as described above.

### BRIEF DESCRIPTION OF THE DRAWINGS

Further features and advantages of the invention will emerge from the following description of an embodiment which is shown in the accompanying drawings, in which

FIG. 1 is a diagram showing the steps of the method according to the invention by means of a press die with A) pressing the press die located above into the substrate, B) raising the press die, C) applying the ink into the channel formed in the substrate and D) sintering the ink material in the channel

FIG. 2 is a microphotograph of a cross-section through a polystyrene sheet with stamped channels

FIG. 3 is an enlarged view of the cross-section through a polystyrene sheet with sintered silver conductor

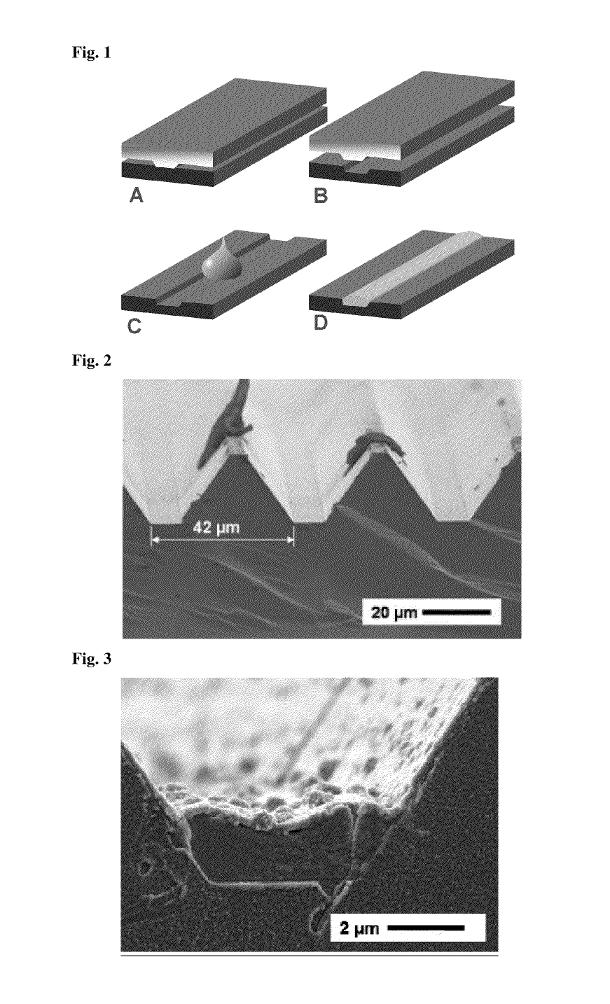

### EXAMPLES

### Example 1

A grid of channels on a polymer substrate has been fabricated by pressing a grid structure (MASTER) into a polystyrene substrate with a glass transition temperature Tg of 100° C. (N5000, Shell AG). For this purpose, the MASTER was heated to 180° C. and pressed onto the substrate for 3 minutes with a load of 3 kg by means of a small press (Tribotrak, DACA Instruments, Santa Barbara, Calif., USA). The MASTER displayed a line interval of 42 μm, the depressions in the MASTER, when viewed in cross-section, appearing as cut-off triangles standing on their heads (FIG. 2). The elevations in the MASTER display a height of 20 μm and are also cut-off triangles when viewed in cross-section. The base width of the elevations in the MASTER was 32 μm and the width at the peak of the elevations approximately 4.5 μm.

A single droplet of a silver nano-ink (Nanopaste™, Harima Chemicals, Japan) was placed on one of the lines fabricated as described above. The ink consists of a dispersion of silver nanoparticles of an average diameter of approximately 5 nm in tetradecane. Due to the capillary action, a line of ink forms immediately in the channels. It was possible to maintain a uniform line approximately 4 mm long. The precise positioning of the ink droplet was achieved by means of an inkjet system (Autodrop™ system; Microdrop Technologies, Norderstedt, Germany). The system was equipped with a 68 μm jet head. The maximum width of the resulting silver line was approximately 6.3 μm at full height, as can be seen in FIG. 3. The width was approximately 3.7 μm at its narrowest position (see FIG. 3 base). Next, the substrate was tempered for 1.5 h at 200° C., the ink being converted into a continuous line consisting of sintered silver. The deviation between the width of the depressions at their base (3.7 μm) and the corresponding width of the upper edges of the MASTER profile (4.5 μm) can be explained by the swelling of the substrate under the effect of the ink solvent and the heating of the substrate during stamping. Resistance of 2.5Ω was measured on a stretch of 6 mm on 4 parallel lines.

### Example 2

A grid of channels was created by pressing a grid into a polycarbonate film with a glass transition temperature Tg of 205° C. (Bayfol®, Bayer MaterialScience AG), which was heated to 270° C. All further stamping parameters corresponded to Example 1. In the same way as in Example 1, a conductive line was also created. The line width achieved and lengths of electrically conductive silver conductor paths were identical to those of the paths created in Example 1.

### Example 3

The method was the same as in Example 1, but a press roller was used instead of the stamping method with a press die.

Continuous structures on a 10 mm thick polycarbonate substrate (Makrolon, Bayer, Germany, glass temperature 148° C.) were created by means of a roller mounted on a small press (Tribotrak, DACA Instruments, Santa Barbara, Calif., USA). The specially finished roller, mounted on the small press, possessed raised line structures with a width of 10 μm and an interval of 3 mm. In this arrangement, the surface of the substrate was heated to 60° C., while the roller had a temperature of 155° C. The pressure of the press was set on the assembly mentioned above by means of a weight of 10 kg. A relative drive speed from roller to substrate of 0.25 mm/s was selected for the temperatures set and the pressure used. In this arrangement, the substrate was pulled along under the roller by means of a slide, in order to achieve the relative speed indicated above. The pressure was sufficient for the roller to rotate on the substrate.

1. Method for fabricating electrically conductive structures that have a dimension of not more than 25 μm in two dimensions, on an optically transparent substrate with mouldable surface, which comprises
ii) mechanically and/or thermally creating channels on the surface of the substrate,
iii) applying an ink capable of forming electrically conductive structures onto the channels,
iv) filling the channels with said ink by capillary action,
v) converting the ink in the channels into conductive structures by introducing energy thereto.

2. Method according to claim 1, wherein said ink is a suspension of particles of an electrically conductive material, or of a precursor compound for an electrically conductive material, in a solvent.

3. Method according to claim 1, wherein said particles or precursor compound are selected from the group consisting of carbon nanotubes, electrically conductive polymer, metal nanoparticles, metal oxide nanoparticles.

4. Method according to claim 3, wherein said particles or precursor compound are silver nanoparticles.

5. Method according to claim 2, wherein said ink is a suspension of electrically conductive particles and said electrically conductive particles have a diameter of less than 1 μm in their greatest dimension.

6. Method according to claim 1, wherein the channels on the transparent substrate have a width not exceeding 25 μm.

7. Method according to claim 1, wherein the channels are stamped onto the surface of the substrate by means of a press die or press roller, the press die or press roller being optionally heated.

8. Method according to claim 7, wherein the substrate is a transparent polymer and the press die or press roller has a temperature that is above the glass transition temperature of the polymer.

9. Method according to claim 8, wherein said temperature is at least 20° C. above said glass transition temperature.

10. Method according to any of claims 1 to 7, characterised in that the ink is introduced onto the channels by means of the inkjet pressure method.

11. Substrate with electrically conductive structures, which structures do not exceed 25 μm in each of two dimensions, obtained according to the method of claim 1.
